(19) United States
(12) Patent Application Publication
(10) Pub. No.: US 2010/0041780 A1
(43) Pub. Date: Feb. 18, 2010

(54) HALOGEN-FREE, FLAME-RETARDANT POLYURETHANE FOAMS WITH LOW SCORCH LEVEL

(75) Inventors: ANNE FRIEDRICH, Leverkusen (DE); JAN-GERD HANSEL, BERGISCH GLADBACH (DE); HEIKO TEBBE, DORMAGEN (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, LEVERKUSEN (DE)

(21) Appl. No.: 12/538,257

(22) Filed: Aug. 10, 2009

(30) Foreign Application Priority Data
Aug. 16, 2008 (DE) 10 2008 038 054.7

(51) Int. Cl. C08K 5/52

(52) U.S. Cl. 521/107

(57) ABSTRACT

The present invention relates to halogen-free flame-retardant polyurethane foams with low scorch level which comprise, as flame retardant, a mixture composed of at least one polyaryl phosphate and of at least one monoaryl phosphate, and also to a method for the production of these foams, and to their use.

The present invention relates to halogen-free flame-retardant polyurethane foams with low scorch level which comprise, as flame retardant, a mixture composed of at least one polyaryl phosphate and of at least one monoaryl phosphate, and also to a method for the production of these foams, and to their use.

### BACKGROUND OF THE INVENTION

Polyurethane foams are plastics used in many sectors, such as furniture, mattresses, transport, construction and technical insulation. In order to meet stringent flame retardancy requirements, for example those demanded for materials in sectors such as the automotive sector, railroad sector and aircraft-interior-equipment sector, and also for insulation in buildings, polyurethane foams generally have to be modified with flame retardants. A wide variety of different flame retardants is known for this purpose and is commercially available. However, their use is complicated by a wide variety of considerable application-related problems or toxicological concerns.

For example, when solid flame retardants, e.g. melamine, ammonium polyphosphate and ammonium sulphate are used, technical problems of metering arise because of sedimentation or aggregation, and these often necessitate modifications to the foaming plants, i.e. complicated reengineering and adaptation.

The frequently used flame retardants tris(chloroethyl) phosphate, tris(chloroisopropyl) phosphate and tris(dichloroisopropyl) phosphate are liquids that are easy to meter, but an increasing requirement recently placed on open-cell flexible polyurethane foam systems for automobile-interior equipment is that the gaseous emissions (volatile organic compounds, VOCs), and especially the condensable emissions (fogging) from these foams are not to exceed low threshold values. The abovementioned liquids now fail to meet these requirements because they have excessive volatility.

Fogging is the undesired condensation of vaporized volatile constituents from interior equipment of a motor vehicle onto panes of glass, in particular on the windscreen. DIN 75 201 (German Industrial Norm corresponding to ISO 6452 for the determination of the windscreen fogging characteristics of trim materials in motor vehicles) permits quantitative assessment of this phenomenon. A typical requirement of the automobile industry is that fogging condensate must be less than 1 mg by the DIN 75201 B method.

Preference is also given to halogen-free flame retardants, for reasons of environmental toxicology, and also in order to ameliorate side-effects in the event of a fire, in relation to smoke density and smoke toxicity. Halogen-free flame retardants can also be of particular interest for application-related reasons. For example, when halogenated flame retardants are used severe corrosion phenomena are observed on the plant components used for flame lamination of polyurethane foams. This can be attributed to the hydrohalic acid emissions arising during the flame lamination of halogen-containing polyurethane foams.

Flame lamination is a term used for a process for the bonding of textiles and foams by using a flame for incipient melting of one side of a foam sheet and then immediately pressing a textile web onto this side.

The automobile industry and furniture industry are increasingly demanding that the flame retardants used minimize the scorch level, particularly in open-cell polyurethane foams.

The term scorch is used for the undesired discoloration of the core in polyurethane foams. The likely cause of scorch is thermal and oxidative degradation of the polyurethane foam in the presence of water. Mechanistic studies have shown that the discoloration of the core is attributable to oxidation products of the aromatic amines that result from the hydrolysis of the isocyanate groups [Luda, M. P., Bracco, P., Costa, L., Levchik, S. V. (2004). Discoloration in Fire Retardent Flexible Polyurethane Foam. Part I. Characterization, Polym. Degrad. Stab., 83: 215-220; Levchik, S. V., Luda, M. P., Bracco, P., Nada, P., Costa, L. (2005). Discoloration in Fire Retardent Flexible Polyurethane Foam, J. Cellular Plast., 41 (3): 235-250]. Scorch is generally observed in the centre of the polyurethane foam slab, since this is the region subject to a prolonged period of increased internal temperature.

Flame retardants can exert a considerable effect on the scorch behaviour of a polyurethane foam. Brominated diphenyl ethers, dialkyl tetrabromophthalates and aryl phosphates are low-scorch flame retardants. Accordingly, only aryl phosphates provide the combination of a low scorch level and freedom from halogen.

Triphenyl phosphate is a readily available aryl phosphate and known by way of example from EP 0 170 206 A1 as a highly effective flame retardant in polyurethane foams. However, the fact that the melting point of triphenyl phosphate is 49° C. and that, at a processing temperature of about 20° C., it therefore has the attendant problems described above for the use of solid flame retardants has to be considered a serious disadvantage.

Alkyl-substituted aryl phosphates, e.g. diphenyl cresyl phosphate (EP-A 0 308 733) are generally liquid and therefore easy to process as flame retardants for polyurethane foams. WO-A 2006119369 describes a liquid flame retardant for polyurethane foams which is composed of a combination of triphenyl phosphate, alkylated triphenyl phosphates and a polyol crosslinking agent. EP-A 1 506 256 describes mixtures of alkyl-substituted triaryl phosphates with phosphorus-containing flame retardants for polyurethane foams. WO 2006060573 A1 describes flame-retardant polyurethane foams with low scorch level, comprising alkylated phenyl phosphates with varying phosphite contents.

Alkyl-substituted aryl phosphates contain less phosphorus than triphenyl phosphate. The lower phosphorus content leads to a lower level of flame-retardant effect.

It is an object of the present invention to provide halogen-free flame-retardant polyurethane foams which feature low fogging values together with a low scorch level. The flame retardants required for this purpose are intended to be readily available liquids which are easy to process, and to be capable of providing high effectiveness even when the amount used is small.

### SUMMARY OF THE INVENTION

The said object is achieved via flame-retardant polyurethane foams which comprise, as flame retardant, a mixture composed of

a) at least one halogen-free polyaryl phosphate of the general formula (I)

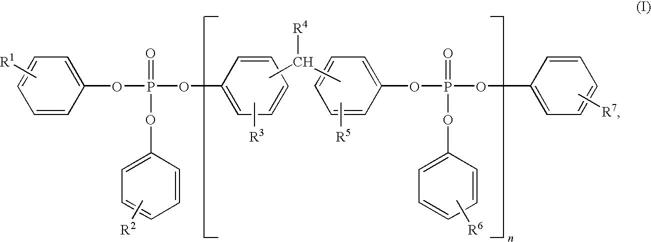

and
b) at least one halogen-free monoaryl phosphate of the general formula (II)

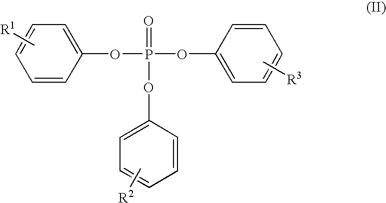

in which
R¹, R², R³, R⁵, R⁶ and R⁷ are in each case, independently of each other, H or a straight-chain, branched or cyclic C₁-C₄-alkyl moiety or phenyl,
R⁴ is H or a straight-chain, branched or cyclic C₁-C₁₀-hydrocarbon moiety and
n is a number from 1 to 20.

The term “halogen-free” means that the polyaryl phosphates and monoaryl phosphates do not comprise a proportion by weight greater than 0.1% of the elements fluorine, chlorine, bromine and/or iodine.

For clarification, it should be noted that the scope of the invention encompasses any desired combination of the definitions and parameters mentioned below in general terms or in preferred ranges.

According to the formulae (I) and (II), the moieties R¹, R², R³, R⁵, R⁶ and R⁷, and also the bridging alkylidene moiety R⁴—CH, can, independently of one another, have ortho-, meta- and/or para-position on the six-membered ring relative to the C—O bond.

It is preferable that R¹, R², R³, R⁵, R⁶ and R⁷, independently of one another, are H or methyl, and it is particularly preferable that R¹, R², R³, R⁵, R⁶ and R⁷ are H.

It is preferable that R⁴ is H, methyl or phenyl, and it is particularly preferable that R⁴ is H.

It is preferable that the polyaryl phosphates of the formula (I) are mixtures composed of a plurality of structurally similar components which differ by way of example in the number n, in the moieties R¹, R², R³, R⁴, R⁵, R⁶ and R⁷, and/or in the types of substitution of the said moieties, i.e. ortho, meta or para. These mixtures can comprise not only the linear polyaryl phosphates of the formula (I) but also further polyaryl phosphates which are branched, star-shaped, or cyclic, or crosslinked in some other manner.

The flame-retardant and scorch-protected polyurethane foams preferably comprise, based on the entire polyurethane foam,

a) from 0.1 to 20% by weight of polyaryl phosphates of the formula (I) and
b) from 0.1 to 20% by weight of monoaryl phosphates of the formula (II).

In a particularly preferred form of the invention, the polyurethane foams comprise

a) from 0.5 to 16% by weight of polyaryl phosphates of the formula (I) and
b) from 0.5 to 16% by weight of monoaryl phosphates of the formula (II).

It is preferable that the mixture composed of polyaryl phosphates and of monoaryl phosphates is a liquid at the processing temperature. The term processing temperature here means the temperature at which the polyurethane raw materials are introduced into the metering and mixing assemblies of the foaming plants. Temperatures of from 20 to 80° C. are generally selected here as a function of the viscosities of the components and of the design of the metering assemblies. It is preferable that the viscosity of the liquid mixture composed of polyaryl phosphates and of monoaryl phosphates at 20° C. is from 10 mPas to 5000 mPas, preferably from 50 mPas to 2000 mPas.

The polyaryl phosphates and monoaryl phosphates present in the polyurethane foams according to the invention are known to the person skilled in the art and are readily available. By way of example, they can particularly advantageously be obtained in the form of a mixture if monoaryl phosphates of the formula (II) are reacted with substoichiometric amounts of aldehydes R⁴—CHO, where R⁴ is defined as above, or with derivatives of these, with removal of water. This is described by way of example in EP 0 001 215 A1.

The flame-retardant polyurethane foams according to the invention are preferably produced by reacting organic polyisocyanates with compounds having at least two hydrogen atoms reactive towards isocyanates, using conventional blowing agents, stabilizers, activators, and/or further conventional auxiliaries and additives, in the presence of halogen-free polyaryl phosphates of the formula (I) and of monoaryl phosphates of the formula (II).

The polyurethane foams are isocyanate-based foams which mainly have urethane groups and/or isocyanurate groups and/or allophanate groups and/or uretdione groups and/or urea groups and/or carbodiimide groups. The production of isocyanate-based foams is known and is described by way of example in DE-A 16 94 142 (=GB 1 211 405), DE-A 16 94 215 (=U.S. Pat. No. 3,580,890) and DE-A 17 20 768 (=U.S. Pat. No. 3,620,986) and also in Kunststoff-Handbuch [Plastics Handbook] Volume VII, Polyurethane [Polyurethanes], edited by G. Oertel, Carl Hanser Verlag Munich, Vienna, 1993.

Polyurethane foams are broadly divided into flexible and rigid foams. Although flexible and rigid foams can in principle have approximately the same envelope density and constitution, flexible polyurethane foams have only a low degree of crosslinking and have only a low resistance to deformation under pressure. In contrast to this, the structure of rigid polyurethane foams is composed of highly crosslinked units, and rigid polyurethane foam has very high resistance to deformation under pressure. The typical rigid polyurethane foam is of closed-cell type and has a low coefficient of thermal conductivity. In the production of polyurethanes, which proceeds by way of the reaction of polyols with isocyanates, the subsequent structure of the foam and its properties are influenced primarily by way of the structure and molar mass of the polyol and also by way of the reactivity and number (functionality) of the hydroxy groups present in the polyol. Further details concerning rigid and flexible foams and the starting materials that can be used for their production, and also concerning processes for their production, are found in Norbert Adam, Geza Avar, Herbert Blankenheim, Wolfgang Friederichs, Manfred Giersig, Eckehard Weigand, Michael Halfmann, Friedrich-Wilhelm Wittbecker, Donald-Richard Larimer, Udo Maier, Sven Meyer-Ahrens, Karl-Ludwig Noble and Hans-Georg Wussow: “Polyurethanes”, Ullmann's Encyclopedia of Industrial Chemistry Release 2005, Electronic Release, 7th ed., chap. 7 (“Foams”), Wiley-VCH, Weinheim 2005.

The envelope densities of the inventive polyurethane foams are preferably from 10 to 130 kg/m³. Their envelope densities are particularly preferably from 15 to 40 kg/m³.

The following starting components are used for the production of the isocyanate-based foams to be protected according to the invention:
1. Aliphatic, cycloaliphatic, araliphatic, aromatic and heterocyclic polyisocyanates (e.g. W. Siefken in Justus Liebigs Annalen der Chemie, 562, pp. 75-136), preferably those of the formula Q(NCO)ₙ, in which n=from 2 to 4, preferably from 2 to 3, and Q is an aliphatic hydrocarbon radical having from 2 to 18, preferably from 6 to 10, carbon atoms, a cycloaliphatic hydrocarbon radical having from 4 to 15, preferably from 5 to 10, carbon atoms, an aromatic hydrocarbon radical having from 6 to 15, preferably from 6 to 13, carbon atoms, or an araliphatic hydrocarbon radical having from 8 to 15, preferably from 8 to 13, carbon atoms. Particular preference is generally given to the polyisocyanates which are readily accessible industrially and which derive from tolylene 2,4- and/or 2,6-diisocyanate or from diphenylmethane 4,4′- and/or 2,4′-diisocyanate.
2. Compounds having at least two hydrogen atoms reactive towards isocyanates and whose molar mass is from 400 to 8000 g/mol (“polyol component”). These are not only compounds having amino groups, thio groups or carboxy groups, but also preferably compounds having hydroxy groups, in particular compounds having from 2 to 8 hydroxy groups. If the polyurethane foam is intended to be a flexible foam, it is preferable to use polyols whose molar masses are from 2000 to 8000 g/mol and which have from 2 to 6 hydroxy groups per molecule. If, in contrast, the intention is to produce a rigid foam, it is preferable to use highly branched polyols whose molar masses are from 400 to 1000 g/mol and which have from 2 to 8 hydroxy groups per molecule. The polyols are polyethers and polyesters and also polycarbonates and polyesteramides, as known per se for production of homogeneous and cellular polyurethanes and as described by way of example in
   DE-A 28 32 253. According to the invention, preference is given to polyesters and polyethers having at least two hydroxy groups.

The inventive polyurethane foams can therefore be produced in the form of rigid or flexible foams by selecting the starting materials appropriately in a manner easily found in the prior art.

In one preferred embodiment, further starting components are compounds having at least two hydrogen atoms reactive towards isocyanates and having a molecular weight of from 32 to 399. Here again these are compounds having hydroxy groups and/or amino groups and/or thio groups and/or carboxy groups, preferably compounds having hydroxy groups and/or amino groups, where these compounds serve as chain extenders or crosslinking agents. These compounds generally have from 2 to 8, preferably from 2 to 4, hydrogen atoms reactive towards isocyanates. Examples here are likewise described in DE-A 28 32 253 (=U.S. Pat. No. 4,263,408).
3. As blowing agents, water and/or volatile substances, e.g. n-pentane, isopentane, cyclopentane, halogen-containing alkanes, such as trichloromethane, methylene chloride or chlorofluoroalkanes, gases, such as CO₂, and other compounds. It is also possible to use a mixture of a plurality of blowing agents.
4. In another preferred embodiment, concomitant use is made of auxiliaries and additives, such as catalysts of the type known per se, surfactant additives, such as emulsifiers and foam stabilizers, reaction retarders, e.g. acidic substances, such as hydrochloric acid or organic acyl halides, or else cell regulators of the type known per se, such as paraffins or fatty alcohols and dimethylpolysiloxanes, and also pigments or dyes and further flame retardants, or else stabilizers to protect from the effects of ageing and weather, core discoloration inhibitors, plasticizers and fungistatic and bacteriostatic substances, and also fillers, such as barium sulphate, kieselguhr, carbon black or whiting (DE-A 27 32 292=U.S. Pat. No. 4,248,930). Particular core discoloration inhibitors that can be present are sterically hindered trialkylphenols, alkyl esters of 3-(3,5-di-tert-butyl-4-hydroxyphenyl)propionic acid, benzofuran-2-ones, secondary aromatic amines, phosphites, phenothiazines or tocopherols.

In one particularly preferred embodiment, further flame retardants that can be present alongside the mixture composed of polyaryl phosphates and of monoaryl phosphates in the polyurethane foams are
a) organophosphorus compounds, in particular aliphatic triethyl phosphate, bisphosphates, neopentyl glycol bis(diphenyl phosphate), chlorine-containing phosphoric esters, e.g. tris(chloroisopropyl) phosphate or tris(dichloropropyl) phosphate, dimethyl methanephosphonate, diethyl ethanephosphonate, dimethyl propanephosphonate, oligomeric phosphates or phosphonates, phosphorus compounds containing hydroxy groups, 5,5-dimethyl-1,3,2-dioxaphosphorinane 2-oxide derivatives,
b) inorganic phosphorus-containing salts, in particular ammonium phosphate, ammonium polyphosphate, melamine phosphate, melamine polyphosphate, metal salts of dialkylphosphiric acids, metal salts of alkanephosphoric acids,
c) nitrogen compounds, in particular melamine, melamine cyanurate,
d) chlorine and bromine compounds, in particular alkyl esters of a tetrabromobenzoic acid, bromine-containing diols prepared from tetrabromophthalic anhydride, bromine and/or chlorine-containing polyols,
e) inorganic flame retardants, in particular aluminium hydroxide, boehmite, magnesium hydroxide, expandable graphite or clay minerals.

Other examples of materials to be used concomitantly according to the invention, if appropriate, in the form of surfactant additives and foam stabilizers and also cell regulators, reaction retarders, stabilizers, flame-retardant substances, plasticizers, dyes and fillers and also substances having fungistatic or bacteriostatic action are described in Kunststoff-Handbuch [Plastics Handbook], Volume VII, Carl Hanser Verlag, Munich, 1993, on pages 104-123, as also are details concerning use of these additives and their mode of action.

The present invention also encompasses a method for the production of flame-retardant polyurethane foams via reaction of organic polyisocyanates with compounds having at least two hydrogen atoms reactive towards isocyanates, and optionally with blowing agents, stabilizers, activators, and further auxiliaries and additives, at from 20 to 80° C., characterized in that, as flame retardant, a mixture is used composed of
a) from 0.1 to 40 parts, preferably from 1 to 30 parts, based on 100 parts of polyol component, of at least one halogen-free polyaryl phosphate of the general formula (I)

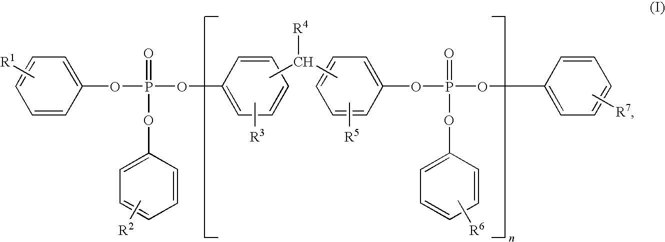

and
b) from 0.1 to 40 parts, preferably from 1 to 30 parts, based on 100 parts of polyol component, of at least one halogen-free monoaryl phosphate of the general formula (II)

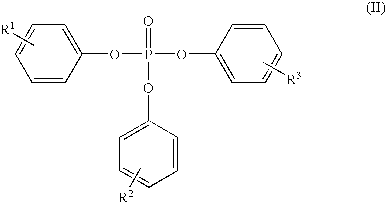

in which
R¹, R², R³, R⁵, R⁶ and R⁷ are in each case, independently of each other, H or a straight-chain, branched or cyclic C₁-C₄-alkyl moiety or phenyl,
R⁴ is H or a straight-chain, branched or cyclic C₁-C₁₀-hydrocarbon moiety and
n is a number from 1 to 20.

In one preferred embodiment of the method, polyaryl phosphates and monoaryl phosphates are used in which according to the formulae (I) and (II) the moieties R¹, R², R³, R⁵, R⁶ and R⁷, independently of one another, are H or methyl. It is particularly preferable that the moieties R¹, R², R³, R⁵, R⁶ and R⁷ are H.

In another preferred embodiment of the method, polyaryl phosphates are used in which according to the formula (I) the moiety R⁴ is H, methyl or phenyl. It is particularly preferable that the moiety R⁴ is H.

It is preferable that the polyaryl phosphates are mixtures composed of a plurality of structurally similar components which differ by way of example in the number n, in the moieties R¹, R², R³, R⁴, R⁵, R⁶ and R⁷ and/or in the types of substitution of these moieties, i.e. ortho, meta or para.

Conduct of method for the production of polyurethane foams:

The reaction components described above are preferably reacted by the single-stage method known per se, by the prepolymer method or by the semiprepolymer method, often using machinery such as the type described in U.S. Pat. No. 2,764,565. Details concerning processing equipment which can also be used according to the invention are described by way of example on pages 139 to 192 of Kunststoff-Handbuch [Plastics Handbook] Volume VII, Polyurethane [Polyurethanes], edited by G. Oertel, Carl Hanser Verlag Munich, Vienna, 1993.

According to the invention it is also possible to produce low-temperature-curing foams (GB Patent 11 62 517, DE-A 21 53 086). However, it is, of course, also possible to produce foams via slab foaming or by the twin-conveyor-belt method known per se. Polyisocyanurate foams are produced by using the methods and conditions known for this purpose.

The method according to the invention permits the production of flame-retardant polyurethane foams in the form of rigid or flexible foams, by a continuous or batchwise production method, or in the form of moulded foam products. The method according to the invention is preferred in the production of flexible foams produced by a slab foaming method.

The products obtainable according to the invention are used by way of example in the following applications: furniture padding, textile inserts, mattresses, seats, preferably aircraft seats or automobile seats, armrests and modules, and also seat coverings and cladding over technical equipment.

However, the present invention also provides the use of a mixture composed of
a) at least one halogen-free polyaryl phosphate of the general formula (I)

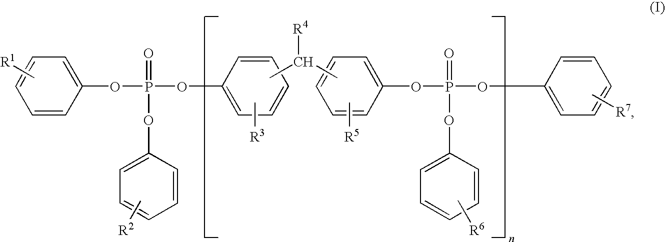

and
b) at least one halogen-free monoaryl phosphate of the general formula (II)

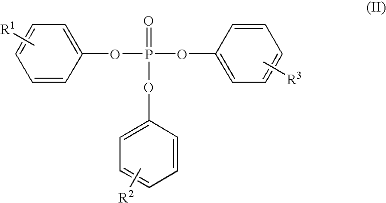

in which
R¹, R², R³, R⁵, R⁶ and R⁷ are in each case, independently of each other, H or a straight-chain, branched or cyclic C₁-C₄-alkyl moiety or phenyl,
R⁴ is H or a straight-chain, branched or cyclic C₁-C₁₀ hydrocarbon moiety and
n is a number from 1 to 20,
   for avoidance of scorch and of fogging in and, respectively, from halogen-free, flame-retardant polyurethane foams.

Finally, the present invention also provides a method for the avoidance of fogging or scorch from and, respectively, in flame-retardant polyurethane foams, characterized in that, as flame retardant, a mixture is used composed of
a) at least one halogen-free polyaryl phosphate of the general formula (I)

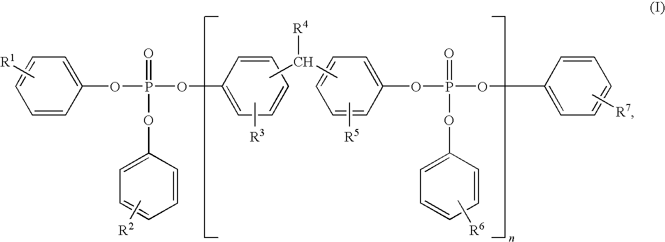

and
b) at least one halogen-free monoaryl phosphate of the general formula (II)

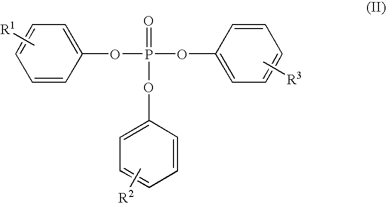

in which
R¹, R², R³, R⁵, R⁶ and R⁷ are in each case, independently of each other, H or a straight-chain, branched or cyclic C₁-C₄-alkyl moiety or phenyl,
R⁴ is H or a straight-chain, branched or cyclic C₁-C₁₀ hydrocarbon moiety and
n is a number from 1 to 20.

The examples below provide further explanation of the invention, but there is no intention that the invention be restricted thereby.

It will be understood that the specification and examples are illustrative but not limitative of the present invention and that other embodiments within the spirit and scope of the invention will suggest themselves to those skilled in the art.

### EXAMPLES

The parts stated are based on weight.

TABLE 1
Materials used.

| Component | Function | Description |
|---|---|---|
| A | Polyol | Arcol ® 1105 (Bayer Material Science AG), |
| | | polyether polyol having OH number 56 mg KOH/g |
| B | Blowing agent | Water |
| C | Catalyst | Niax ® A-1 (GE Silicones), 70% strength solution of |
| | | bis(2-dimethylaminoethyl) ether in dipropylene glycol |
| D | Catalyst | Desmorapid ® SO (Rheinchemie), tin(II) 2-ethylhexanoate |
| E | Stabilizer | Tegostab ® B 8232 (Degussa), silicone stabilizer |
| F1 | Flame retardant | Tris(dichloroisopropyl) phosphate, TDCP, |
| | | CAS Reg. No 13674-87-8 |
| F2 | Flame retardant | Diphenyl cresyl phosphate, CAS Reg. No 26444-49-5 |
| F3 | Flame retardant | Bisphenol A bis(diphenyl phosphate), |
| | | CAS Reg No 181028-79-5 |
| F4 | Flame retardant | Reaction product from the reaction of triphenyl phosphate with |
| | | paraformaldehyde according to EP 0 001 215 A1 |
| | | Viscosity 311 mPas at 20° C. |
| | | Triphenyl phosphate content according to GC: 54% by weight |
| F5 | Flame retardant | Reaction product from the reaction of triphenyl phosphate with |
| | | paraformaldehyde according to EP 0 001 215 A1 |
| | | Viscosity 292 mPas at 20° C. |
| | | Triphenyl phosphate content according to GC: 50% by weight |
| F6 | Flame retardant | Reaction product from the reaction of triphenyl phosphate with |
| | | paraformaldehyde according to EP 0 001 215 A1 |
| | | Viscosity 290 mPas at 20° C. |
| | | Triphenyl phosphate content according to GC: 49% by weight |
| F7 | Flame retardant | Reaction product from the reaction of triphenyl phosphate with |
| | | paraformaldehyde according to EP 0 001 215 A1 |
| | | Viscosity 285 mPas at 20° C. |
| | | Triphenyl phosphate content according to GC: 49% by weight |
| G | Diisocyanate | Desmodur ® T 80 (Bayer Material Science AG), |
| | | tolylene diisocyanate, isomer mixture |

### Production of Flexible Polyurethane Foams

The components specified in Table 1 with the exception of the diisocyanate (component G) were, according to foam type, mixed in the quantitative proportions stated in Table 2, to give a homogeneous mixture. The diisocyanate was then added and incorporated by brief and vigorous mixing. After a cream time of from 15 to 20 s and a full rise time of from 190 to 210 s, the products were flexible polyurethane foams whose envelope density, as a function of formulation, was 26 and, respectively, 33 kg/m³.

### Determination of Flame-Retardant Effect

The flexible polyurethane foams were tested to the specifications of Federal Motor Vehicle Safety Standard FMVSS-302. In this test, test specimen foams of dimensions 210 mm×95 mm×15 mm (L×W×H) fastened in a horizontal holder were ignited in the middle of the short edge for 15 s with a gas burner flame at height 40 mm, and spread of flame was observed after removal of the ignition flame. As a function of whether and how far the burning of the test specimen continued, the specimen was allocated to fire classes SE (self-extinguishing, burning affected less than 38 mm of the specimen), SE/NBR (self-extinguishing within 60 s/no burning rate given), SE/B (self-extinguishing/measurable burning rate), BR (burns as far as the end of the specimen, measurable burning rate) and RB (rapid burning, burning rate not measurable). For each example, the fire tests were carried out five times. Table 2 gives the poorest result of each series of five.

### Determination of Fogging

The fogging behaviour of the flexible polyurethane foams was studied to DIN 75201 B. In this test, cylindrical foam specimens of dimensions 80 mm×10 mm (ø×H) were heated for 16 h to 100° C., and the amounts of condensate deposited on an aluminium foil positioned over the test specimens and cooled to 21° C. were weighed. Table 2 gives the amounts of condensate measured.

### Determination of Scorch Level

The components were mixed and then poured into a 20×20×14 cm paper mould. 5 min after the end of the foaming procedure (the temperature reached in the core of the foam being about 135° C.), the foam was irradiated at 300 W for 4 min in a microwave oven (Mars 5, CEM). The foam was then removed (temperature within the foam being about 160° C.) and cooled overnight. The foam was then cut in half and studied for scorch. For this, the foam was analysed by means of a colorimeter (CR-400/410, Konica Minolta). The colorimeter determined the three colour characteristics of the foam studied: lightness (L), red and green hue (a) and yellow and blue hue (b). The differences dL, da and db were determined in comparison with a scorch-free reference foam. These data were then used to calculate the change in colour (dE) of the foam studied in comparison with the reference foam: dE=(dL²+da²+db²)^{0.5}.

TABLE 2
Constitution (parts) and test results for inventive examples IE1
and IE2 and non-inventive comparative examples CE1 to CE4.

| Example | CE1 | CE2 | CE3 | CE4 | IE1 | IE2 |
|---|---|---|---|---|---|---|
| A | 10 | 10 | 10 | 10 | 10 | 10 |
| B | 3.0 | 3.0 | 3.0 | 3.0 | 3.0 | 3.0 |
| C | 0.1 | 0.1 | 0.1 | 0.1 | 0.1 | 0.1 |
| D | 0.1 | 0.1 | 0.1 | 0.1 | 0.1 | 0.1 |
| E | 0.8 | 0.8 | 0.8 | 0.8 | 0.8 | 0.8 |
| F1 | | 6 | | | | |
| F2 | | | 6 | | | |
| F3 | | | | 6 | | |
| F4 | | | | | 6 | |
| F5 | | | | | | 6 |
| G | 40.9 | 40.9 | 40.9 | 40.9 | 40.9 | 40.9 |
| Envelope density | 33 | 33 | 33 | 33 | 33 | 33 |
| MVSS class | R | SE | B | R | B | B |
| Fogging-[mg] | 0.2 | 0.7 | 0.8 | 0.2 | 0.3 | 0.4 |

### Results

In the absence of a flame retardant (comparative example CE1, Table 2), the flexible polyurethane foam was rapidly consumed by combustion (FMVSS fire class RB), but had a very low fogging value. A foam with tris(dichloroisopropyl) phosphate (comparative example CE2) complied with the fogging value demanded by the automobile industry, at most 1 mg of condensate, and achieved the best FMVSS fire class SE (self-extinguishing) in every repeat of the fire test. However, tris(dichloroisopropyl) phosphate had the attendant disadvantages described above of a halogen-containing flame retardant. Although use of the halogen-free flame retardant diphenyl cresyl phosphate (comparative example CE3) avoided the said problem and gave a low-class pass in the FMVSS test, the fogging value was high. Use of bisphenol A bis(diphenyl phosphate) (comparative example CE4) gave a low fogging value, but fire behaviour was unsatisfactory, with classification RB.

Examples IE1 and IE2 showed that the halogen-free flexible polyurethane foams according to the invention feature an adequate fire class BR in all repeats of the fire test and a very low fogging value.

TABLE 3
Constitution (parts) and test results for inventive examples IE3 to IE4
and non-inventive comparative examples CE5 to CE8.

| Example | CE5 | CE6 | CE7 | CE8 | IE3 | IE4 |
|---|---|---|---|---|---|---|
| A | 100 | 100 | 100 | 100 | 100 | 100 |
| B | 4.5 | 4.5 | 4.5 | 4.5 | 4.5 | 4.5 |
| C | 0.1 | 0.1 | 0.1 | 0.1 | 0.1 | 0.1 |
| D | 0.2 | 0.2 | 0.2 | 0.2 | 0.2 | 0.2 |
| E | 0.8 | 0.8 | 0.8 | 0.8 | 0.8 | 0.8 |
| F1 | | 18 | | | | |
| F2 | | | 18 | | | |
| F3 | | | | 18 | | |
| F6 | | | | | 18 | |
| F7 | | | | | | 18 |
| G | 57.3 | 57.3 | 57.3 | 57.3 | 57.3 | 57.3 |
| Envelope | 26 | 26 | 26 | 26 | 26 | 26 |
| Scorch [dE] | 3.9 | 18 | 7.7 | 7.2 | 5.9 | 9.1 |

In the absence of a flame retardant, the polyurethane foam (CE5, Table 3) had only a low dE value, i.e. a low scorch level. Addition of tris(dichloroisopropyl) phosphate (CE6) gave a foam with a high dE value, i.e. a high scorch level. When the halogen-free flame retardant diphenyl cresyl phosphate (CE7) and bisphenol A bis(diphenyl phosphate) (CE8) were used, the foam exhibited only a low scorch level.

Inventive examples IE3 and IE4 showed that the halogen-free flexible polyurethane foams according to the invention feature a low scorch level.

What is claimed is:

1. A flame-retardant polyurethane foam comprising, as flame retardant, a mixture composed of
a) at least one halogen-free polyaryl phosphate of the general formula (I) 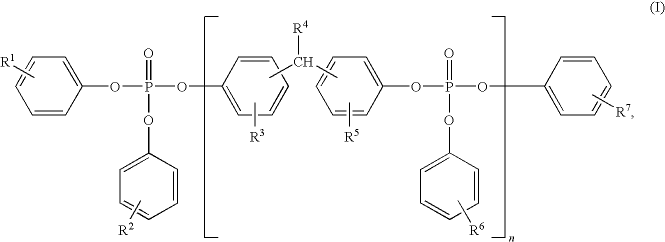
and
b) at least one halogen-free monoaryl phosphate of the general formula (II) 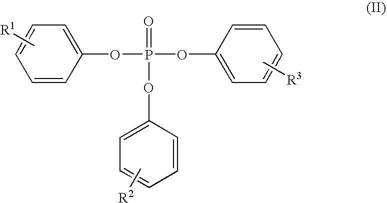
in which
R¹, R², R¹, R⁵, R⁶ and R⁷ are in each case, independently of each other, H or a straight-chain, branched or cyclic C₁-C₄-alkyl moiety or phenyl,
R⁴ is H or a straight-chain, branched or cyclic C₁-C₁₀-hydrocarbon moiety and
n is a number from 1 to 20.

2. A flame-retardant polyurethane foam according to claim 1, wherein R¹, R², R³, R⁵, R⁶ and R⁷, independently of each other, are H or methyl.

3. A flame-retardant polyurethane foam according to claim 1, wherein R⁴ is H, methyl or phenyl.

4. A flame-retardant polyurethane foam according to claim 1, comprising from 0.1 to 20% by weight of polyaryl phosphates of the formula (I) and from 0.1 to 20% by weight of monoaryl phosphates of the formula (II).

5. A flame-retardant polyurethane foam according to claim 1, comprising from 0.5 to 16% by weight of polyaryl phosphates of the formula (I) and from 0.5 to 16% by weight of monoaryl phosphates of the formula (II).

6. A flame-retardant polyurethane foam according to claim 1, wherein the mixture composed of polyaryl phosphate and monoaryl phosphate is a liquid in the temperature range from 20° C. to 80° C.

7. A flame-retardant polyurethane foam according to claim 6, wherein the viscosity of the mixture composed of polyaryl phosphate and monoaryl phosphate at 20° C. is from 10 mPas to 5000 mPas.

8. A flame-retardant polyurethane foam according to claim 1, wherein these are flexible foams.

9. A flame-retardant polyurethane foam according to claim 1, comprising further flame retardants.

10. A method for the production of flame-retardant polyurethane foams via reaction of organic polyisocyanates with compounds having at least two hydrogen atoms reactive towards isocyanates, and optionally with blowing agents, stabilizers, activators or further auxiliaries and additives, at from 20 to 80° C., wherein, a mixture of
a) from 0.1 to 40 parts, based on 100 parts of polyol component, of at least one halogen-free polyaryl phosphate of the general formula (I) 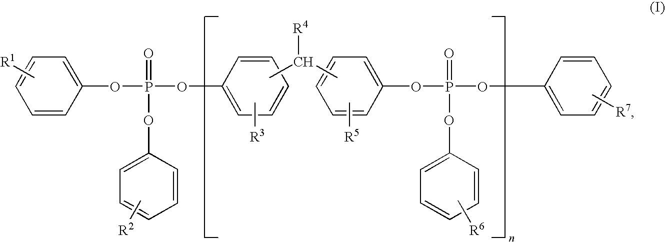
and
b) from 0.1 to 40 parts, based on 100 parts of polyol component, of at least one halogen-free monoaryl phosphate of the general formula (II) 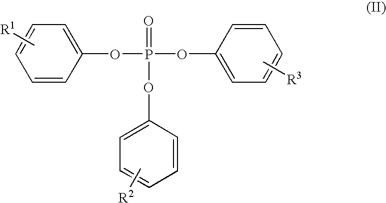
in which
R¹, R², R³, R⁵, R⁶ and R⁷ are in each case, independently of each other, H or a straight-chain, branched or cyclic C₁-C₄-alkyl moiety or phenyl,
R⁴ is H or a straight-chain, branched or cyclic C₁-C₁₀-hydrocarbon moiety and
n is a number from 1 to 20 is used.

11. A method of using the polyurethane foams according to claim 1 in furniture padding, textile inserts, mattresses, seats, armrests, modules, and also seat coverings and cladding over technical equipment.

12. A method of using a mixture composed of
a) at least one halogen-free polyaryl phosphate of the general formula (I) 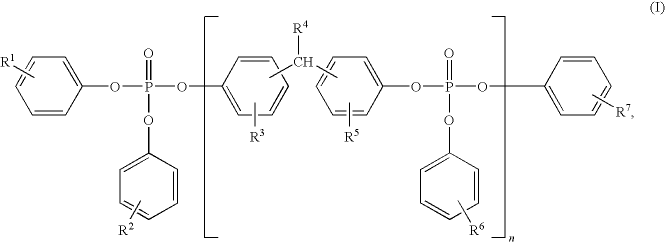
and
b) at least one halogen-free monoaryl phosphate of the general formula (II) 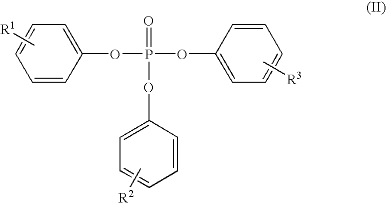
in which
R¹, R², R³, R⁵, R⁶ and R⁷ are in each case, independently of each other, H or a straight-chain, branched or cyclic C₁-C₄-alkyl moiety or phenyl,
R⁴ is H or a straight-chain, branched or cyclic C₁-C₁₀-hydrocarbon moiety and
n is a number from 1 to 20,
for avoidance of scorch and of fogging in and, respectively, from halogen-free, flame-retardant polyurethane foams.

13. A method for the avoidance of fogging and/or scorch from and, respectively, in flame-retardant polyurethane foams, characterized in that, as flame retardant, a mixture composed of
a) at least one halogen-free polyaryl phosphate of the general formula (I) 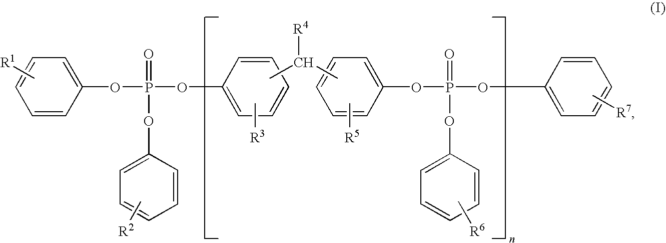
and
b) at least one halogen-free monoaryl phosphate of the general formula (II) 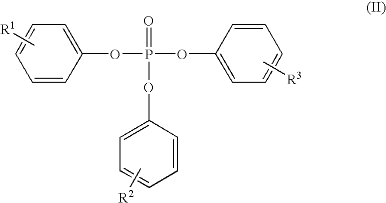
in which
R¹, R², R³, R⁵, R⁶ and R⁷ are in each case, independently of each other, H or a straight-chain, branched or cyclic C₁-C₄-alkyl moiety or phenyl,
R⁴ is H or a straight-chain, branched or cyclic C₁-C₁₀-hydrocarbon moiety and
n is a number from 1 to 20 is used.
